(19) United States
(12) Patent Application Publication
(10) Pub. No.: US 2006/0282764 A1
(43) Pub. Date: Dec. 14, 2006

(54) High-throughput pipelined FFT processor

(75) Inventors: Chen-Yi Lee, Hsinchu City (TW); Yu-Wei Lin, Tainan City (TW)

Correspondence Address: BUCKNAM AND ARCHER, 1077 Northern Blvd., Roslyn, NY, 11576, US

(73) Assignee: National Chiao Tung University

(21) Appl. No.: 11/147,723

(22) Filed: Jun. 8, 2005

(51) Int. Cl. G06F 15/00

(52) U.S. Cl. 715/513

(57) ABSTRACT

The invention proposes a pipelined FFT processor for UWB system, comprising a first module for implementing radix-2 FFT algorithm; a second module is to realize radix-8 FFT algorithm; a third module is to realize radix-8 FFT algorithm; a plurality of conjugate blocks; a division block; and a plurality of multiplexers. The proposed pipelined FFT architecture called Mixed-Radix Multi-Path Delay Feedback (MRMDF) can provide higher throughput rate by using the multi-data-path scheme. The high-radix FFT algorithm is also realized in our processor to reduce the number of complex multiplications.

### BACKGROUND OF THE INVENTION

1. Filed of the Invention

The present invention relates to a fast Fourier transform (FFT) processor, and more particularly, to a FFT processor with a multi-path pipelined architecture for high-throughput-rate applications.

2. Description of the Related Art

Ultra-wideband (UWB) communication systems, which enable to deliver data from a rate of 110 M bit/s at a distance of 10 meters to a rate of 480 M bit/s at a distance of two meters in realistic multi-path environment while consuming very little power and silicon area, are currently the focus of research and development of WPAN (Wireless Personal Area Network). Orthogonal Frequency Division Multiplexing (OFDM) is considered as the leading choice by the 802.15.3a standardization group for use in establishing a physical-layer standard for UWB communications. OFDM-based UWB not only has reliable high-data-rate transmission in time-dispersive or frequency-selective channel without having complex time-domain channel equalizers but also can provide high spectral efficiency. However, because the data sampling rate from Analog-to-Digital converter (A/D) to physical layer is up to 528 M sample/s or more, it is a challenge to realize the physical layer of the UWB system—especially the components with high computational complexity—in VLSI implementation. The FFT/IFFT processor is one of the modules having high computational complexity in the physical layer of the UWB system; and the execution time of the 128 points FFT/IFFT in UWB system is only 312.5 ns. Therefore, if employing the traditional approach, high power consumption and hardware cost of the FFT/IFFT processor will be needed to meet the strict specifications of the UWB system. Thus, this paper proposes a FFT/IFFT processor with a novel multi-path pipelined architecture for high-throughput-rate applications. The power consumption and hardware cost can also be reduced in our processor by using the higher-radix FFT algorithm, less memory and complex multiplier.

### SUMMARY OF THE INVENTION

The present invention is to provide a FFT processor with a multi-path pipelined architecture for high-throughput-rate applications. The power consumption and hardware cost can be reduced in the FFT processor by using the higher-radix FFT algorithm, less memory and complex multiplier.

The proposed pipelined FFT processor for UWB system comprises a first module, a second module, a third module, a plurality of conjugate blocks, a division block, and a plurality of multiplexers.

As a result, the proposed pipelined FFT architecture called Mixed-Radix Multi-Path Delay Feedback (MRMDF) of the present invention can provide higher throughput rate by using the multi-data-path scheme. Furthermore, by means of the delay feedback and the data scheduling approaches, the hardware costs of memory and complex multiplier in MRMDF are only 38.9% and 47.2%, respectively, of those in the known FFT processors. The high-radix FFT algorithm is implemented in our processor to reduce the number of complex multiplications.

### BRIEF DESCRIPTION OF THE DRAWINGS

FIG. 1 is a block diagram showing the proposed 128-point FFT/IFFT processor according to the preferred embodiment of the present invention;

FIG. 2 is a block diagram showing the module 1 according to the preferred embodiment of the present invention;

FIG. 3 is a block diagram showing the module 2 of the preferred embodiment of the present invention;

FIG. 4 is a block diagram showing the module 3 of the preferred embodiment of the present invention.

### DETAILED DESCRIPTION OF THE PREFERRED EMBODIMENTS

Now, the preferred embodiments according to the present invention will be described with references to the accompanying drawings.

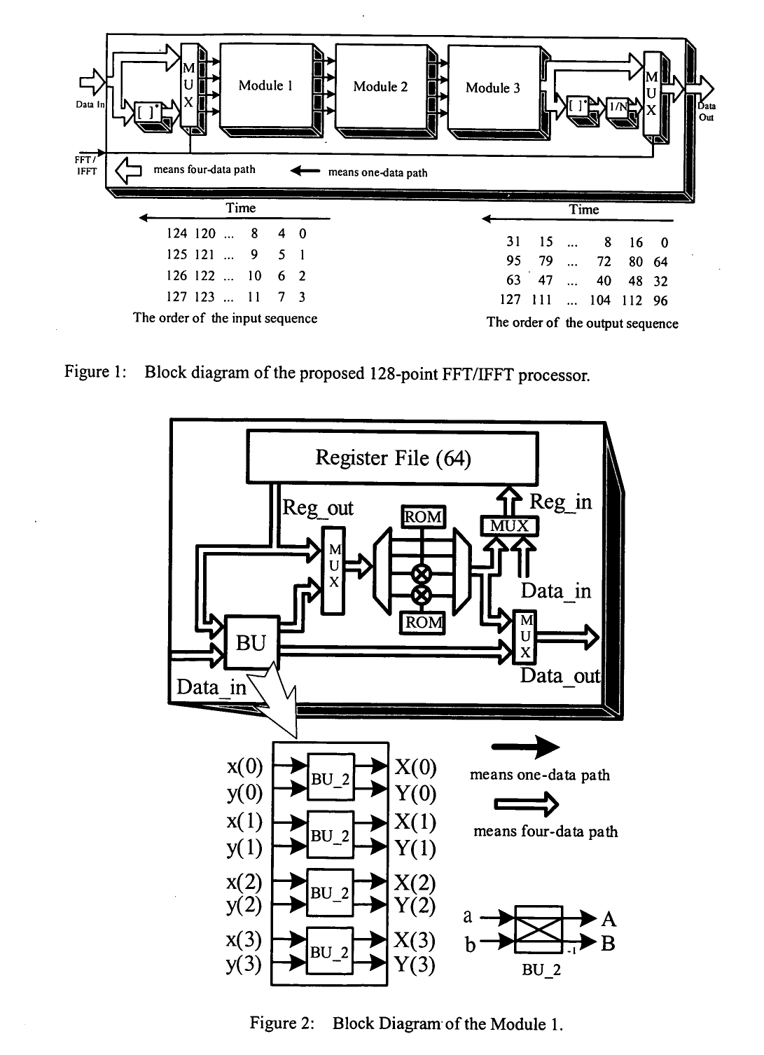

Referring to FIG. 1, the BU consists of four BU_2s, which operate the complex addition and complex subtraction from two input data. Because radix-2 FFT algorithm is adopted in this module, BU can not start until both the input sequences x(n) and x(n+64) are available. This corresponds to the first stage of SFG. The order of the four parallel input sequences in Module 1 is in(4m), in(4m+1), in(4m+2) and in(4m+3) respectively, where m is from 0 . . . 31. So these two available data of each data path are separated by 16 cycles if one input data of each path is available per clock cycle. At the first 16 cycles, the first 64 data are stored in the register file. At the next 16 cycles, the eight input data x(i) and y(i) of the BU are received from the register file and the input respectively. Then the BU generates the outputs data according to radix-2 FFT algorithm. Meanwhile, four output data, X(i), generated by BU, are fed to the Module 2 directly, and the other four output data, Y(i), are stored into the register file. After 32 cycles, these data, Y(i), are read from the register file and are multiplied by the twiddle factors simultaneously before they are sent to Module 2. In general, four complex multipliers are needed in the four-parallel approach to implement radix-2 FFT algorithm. And the utilization rate of the complex multiplier is only 50%. This paper proposes a new approach to increase the utilization rate and to reduce the number of complex multiplier. The detailed operation is described below. When Y(i)s are generated by the BU, two of the Y(i)s, Y(1) and Y(2), are multiplied by the appropriate twiddle factors first before Y(i) s are stored in the register file. After 32 clock cycles, other two Y(i)s, Y(3) and Y(4), are multiplied before the data Y(i)s are fed to Module 2. By rescheduling the time of the complex multiplications, it is clear to find that only two complex multipliers are needed in our approach, as shown in FIG. 2. The utilization of the complex multipliers can achieve 100% by using our proposed approach.

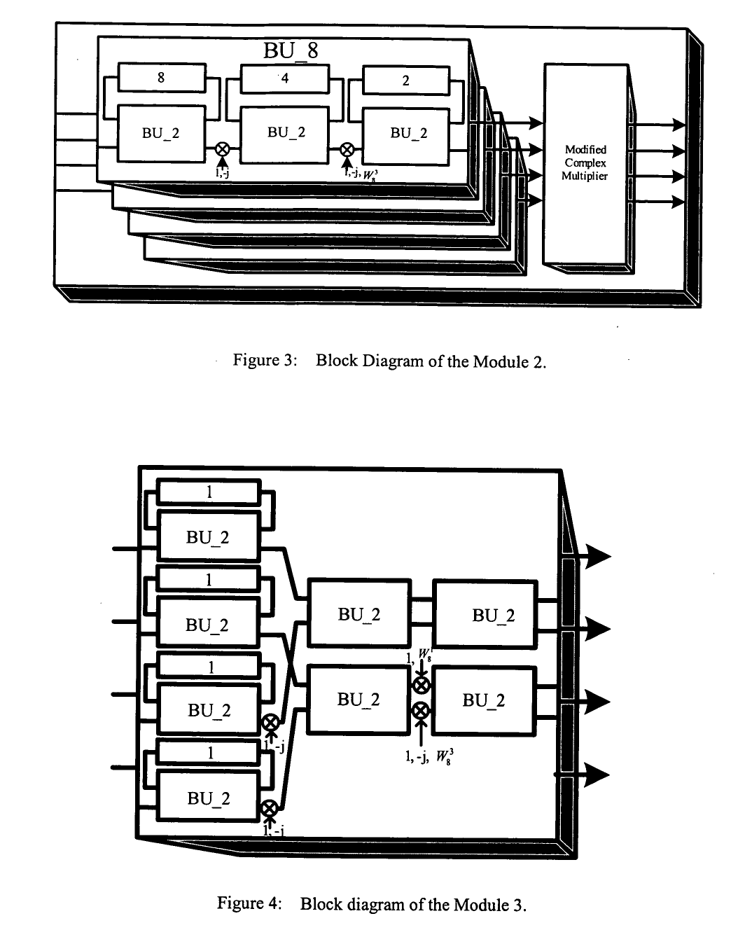

Referring to FIG. 3, Module 2 consists of four BU_8 structures and one modified complex multiplier. These four BU_8s operate in the same way. The architecture of BU_8 is directly mapped from 3-step radix-8 FFT algorithm. And the size of the three delay elements in the BU_8 is eight, four, and two points, respectively. The function of delay element is to store the input data until the other available input data is received for the BU_2 operation. The output data generated by the BU_2 in the first step and second step are multiplied by a trivial twiddle factor, 1,-j, W₈¹ or W₈³ before they are fed to the next step. These twiddle factors can be implemented efficiently. But the four output data from the third step of the BU_8 need to be multiplied by the nontrivial twiddle factors simultaneously in the modified complex multiplier.

It is inefficient to build four complex multipliers for multiplying different twiddle factors simultaneously. The twiddle factors of the modified complex multiplier are

$${W}_{64}^{p} ( {ⅇ}^{\frac{- j2π p}{64}} ) = {X}_{p} + {jY}_{p} , \\ where$$

$${X}_{p} = cos ( \frac{2 π p}{64} )$$

$$and$$

$${Y}_{p} = sin ( \frac{2 π p}{64} )$$

are the real and imaginary parts of the twiddle factor and p is from 0 to 49. However, only nine sets of constant values, (Xₚ, Yₚ) with p=0 to 8 in region A are needed, because the twiddle factor in the other seven regions can be obtained by using the mapping table. In practice, we only need to implement eight sets of constant values in the A region, since the first set of constant values (1, 0) is trivial. And these constant values can be realized more efficiently by using several adders and shifters.

The scheduling of the twiddle factor in each data path after the twiddle factors are mapped to region A. It can be clearly seen that the twiddle factor of four paths in each time slot has different values, except for the time slot 2 and time slot 3. In time slot 2 and time slot 3, the hardware conflict will happen if only one constant multiplier 4 is built. Therefore, an additional constant multiplier, 4, is used in our design to avoid spending one more. At the beginning, the four output sequences from the third step of the BU_8 are separated into real part and imaginary part. The data of each path is fed to appropriate constant multiplier according to the scheduling of the twiddle factor. Therefore, the entire constant multiplication calculation can be implemented by just using eight sets of constant values with swapping the real and imaginary parts appropriately and choosing the appropriate sign according to the mapping table. The gate count of this approach can save about 38% compared to four-complex-multiplier approach. And the performance of this approach is equivalent to that of the four complex multipliers.

According to a preferred embodiment of the present invention, a test chip for UWB system has been fabricated using 0.18 μm single-poly and six-metal CMOS process with core area of 1.76×1.76 mm², including an FFT/IFFT processor and a test module. The throughput rate of this fabricated FFT processor is up to 1 G sample/s while it consumes 175 mW. Power dissipation is 77.6 mW, when its throughput rate meets UWB standard in which the FFT throughput rate is 409.6 M sample/s.

Although the foregoing description has been made with reference to the preferred embodiments, it is to be understood that changes and modifications of the present invention may be made by the ordinary skill in the art without departing from the spirit and scope of the present invention and appended claims.

What is claimed is:

1. A pipelined FFT processor for UWB system, comprising:
a first module for implementing radix-2 FFT algorithm;
a second module for realizing radix-8 FFT algorithm;
a third module for realizing radix-8 FFT algorithm;
a plurality of conjugate blocks;
a division block; and
a plurality of multiplexers.

2. A pipelined FFT processor as claimed in claim 1, wherein said first module further comprising:
a register file for storing 64 complex data;
a butterfly unit for operating the complex addition and complex subtraction from two input data;
two complex multipliers;
two ROMs for storing twiddle factors; and
a plurality of multiplexers.

3. A pipelined FFT processor as claimed in claim 2, wherein said butterfly unit consists of four BU_2s for operating the complex addition and complex subtraction from two input data.

4. A pipelined FFT processor as claimed in claim 1, wherein said second module further comprising:
four BU_8s; and
a modified complex multiplier.

5. A pipelined FFT processor as claimed in claim 4, wherein each of said BU_8 comprising three delay elements for storing the input data, the size of said three delay elements being eight, four, and two points respectively.

6. A pipelined FFT processor as claimed in claim 1, wherein said third module further comprises:
eight BU_8s; and
a modified complex multiplier.
